(19) United States
(12) Patent Application Publication
(10) Pub. No.: US 2005/0275874 A1
(43) Pub. Date: Dec. 15, 2005

(54) Facsimile transmission over data communications networks

(76) Inventor: Rick R. Rothwell, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/853,071

(22) Filed: May 25, 2004

(51) Int. Cl. G06F 15/163; H04N 1/00; H04N 1/32

(52) U.S. Cl. 358/1.15; 358/440; 358/407

(57) ABSTRACT

Various systems and methods of transmitting a document via facsimile are provided. The transmission involves generating, in an origination facsimile device, a facsimile job that includes a document and a facsimile telephone number of a destination facsimile device. Next, a select facsimile server is identified, in the origination facsimile device, that is associated with the destination facsimile device from a plurality of facsimile servers, each of the facsimile servers being coupled to the origination facsimile device via at least one data communications network. Then, the facsimile job is sent to the select facsimile server through the at least one data communications network, wherein the select facsimile server transmits the document to the destination facsimile device through a telecommunications network.

### BACKGROUND

In some networks, a facsimile server may be employed as part of a LAN to transmit facsimiles to receiving facsimile machines. In particular, a facsimile originates, for example, in a scanner device and is provided to the facsimile server that proceeds to initiate a facsimile transfer to the receiving facsimile over a telecommunications network by placing a telephone call to the receiving facsimile. Unfortunately, the cost of such a telephone call may be significant if it is a long distance call. This is especially the case if the telephone call is an international call.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a schematic block diagram of a facsimile transmission network according to various embodiments of the present invention;

FIG. 2 is a schematic block diagram of a scanner client employed in various locations in the facsimile transmission network of FIG. 1 according to an embodiment of the present invention;

FIG. 3 is a schematic block diagram of a scanner client employed in various locations in the facsimile transmission network of FIG. 1 according to an embodiment of the present invention;

FIG. 4 is a drawing of a lookup table employed to identify a facsimile server associated with a particular destination facsimile device in the facsimile transmission network of FIG. 1 according to an embodiment of the present invention;

FIG. 5 is a drawing of a graphical user interface employed to update the lookup table of FIG. 4 according to an embodiment of the present invention; and

FIG. 6 is a flow chart of facsimile routing logic executed in the scanner client of FIG. 2 according to an embodiment of the present invention.

### DETAILED DESCRIPTION

The facsimile transmission network 100 advantageously facilitates the transmission of facsimile jobs from an origination facsimile device to a destination facsimile device while employing a least cost routing due to the use of a network as will be described.

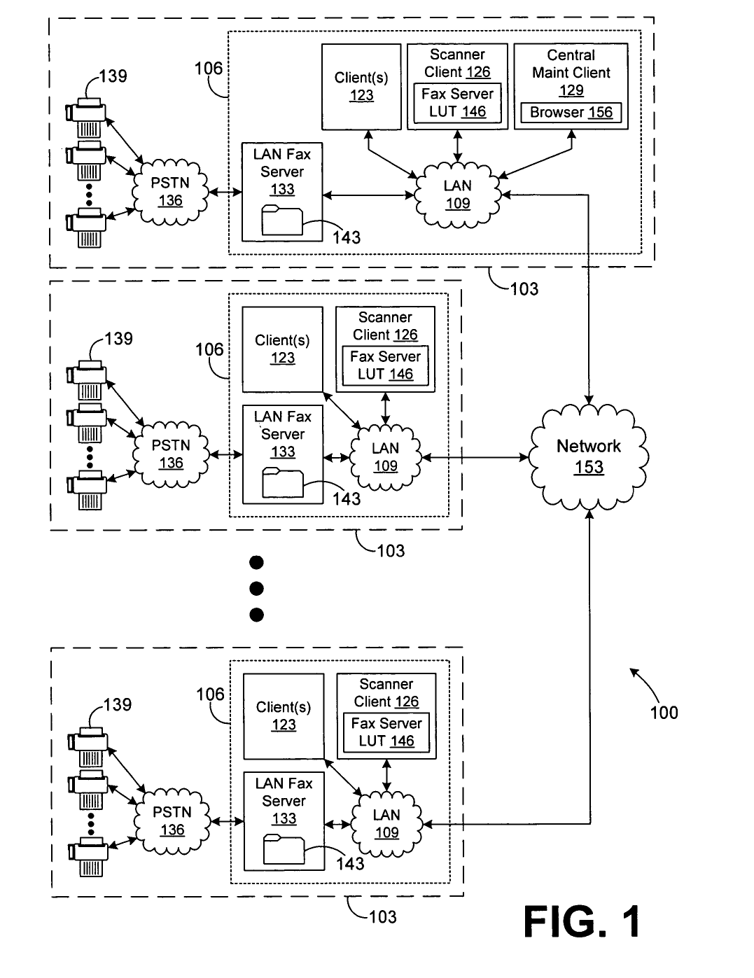

With reference to FIG. 1, shown is a facsimile transmission network 100 according to an embodiment of the present invention. The facsimile transmission network 100 includes a number of geographical regions 103. Each of the geographical regions 103 may be, for example, a metropolitan area, a city, a municipality, a county, or other geographically defined area that is served by the same local telecommunications service as can be appreciated. For example, each geographical region 103 may be a region that coincides with one or more area codes, etc. Within each of the geographical regions 103 is a network site 106 within which is a local area network (LAN) 109. The LAN 109 may be, for example, a network employed within a particular enterprise such as a business, non-profit organization, and the like.

Coupled to the LAN 109, for example, are a number of clients 123, at least one scanner client 126, and a central maintenance client 129. In addition, a LAN facsimile server 133 is coupled to the LAN 109 as well. A central maintenance client 129 is located in one of the network sites 106 as shown.

Each of the clients 123 may be, for example, computer systems, work stations, or other devices typically coupled to a LAN 109 within a given enterprise such as a business, non-profit organization, and the like. Each of the scanner clients 126 may be, for example, a computer system with an accompanying scanner, or a multi-function peripheral that may include various functionality such as scanning, copying, emailing, faxing, and the like as can be appreciated. The central maintenance client 129 may comprise, for example, a computer system or work station that facilitates maintenance of various components within the facsimile transmission network 100 as will be described.

The LAN facsimile server 133 may comprise, for example, a computer system, server, or other like device that facilitates a link between the LAN 109 and a public switched telephone network (PSTN) 136. The LAN facsimile server 133 provides facsimile capability to each of the clients 123, the scanner client 126, and the central maintenance client 129 on the LAN 109. In this respect, the LAN facsimile server 133 receives a facsimile job from any one of the components on the LAN 109 and places an appropriate telephone call to the respective destination facsimile device 139 by way of the public switched telephone network 136. Thus, each LAN facsimile server 133 provides centralized facsimile capability on the LANs 109. In this regard, the PSTN 136 is a telecommunications network that facilitates telecommunications between any two telecommunications devices such as facsimile machines, telephones, or other devices as can be appreciated.

In order to transmit a facsimile job to a respective destination facsimile device 139, any one of the devices coupled to the LAN 109 may place the respective facsimile job into an input folder 143 associated with the LAN facsimile server 133. The input folder 143 may be located within the LAN facsimile server 133 or within some other device located on the LAN 109. In addition, there may be multiple input folders 143 associated with a single LAN facsimile server 133 as will be described. In such a case, each input folder 143 may be associated, for example, with a respective geographical region 103.

In addition, within each of the scanner clients 126 is a facsimile server look-up table (LUT) 146. The facsimile server LUT 146 is employed in the scanner client 126 to route respective facsimile jobs into appropriate input folders 143 of a respective one of the LAN facsimile servers 133 as will be described.

In addition, the central maintenance client 129 includes a browser 156 that is employed to access, for example, each of the facsimile server LUTs 146 in the respective scanner clients 126 in order to alter, add, or delete entries therein as will be described. In this respect, each of the scanner clients 126 include, for example, a web server or other server that facilitates access to the facsimile server LUTs 146 using the browser 156. Each of the LANs 109 is coupled to a data communications network 153. In this respect, the data communications network 153 may be, for example, a wide area network (WAN), the Internet, or other suitable network. In this respect, each of the LANs 109 and the data communications network 153 may be hardwired or wireless, or a combination of hardwire and wireless components, etc.

Next, an explanation of the operation of the facsimile transmission network 100 in transmitting facsimile jobs is described. To begin, a user approaches one of the scanner clients 126 with the intent of scanning in a document, for example, that is to be the subject of a facsimile job that is to be faxed to an appropriate one of the destination facsimile devices 139. Alternatively, one of the clients 123 may include facsimile capability that is manipulated by a particular user to create and send a facsimile job. The device used to create and send a facsimile job is defined herein as a “origination facsimile device”. A facsimile job includes, for example, a document and facsimile telephone number of the destination facsimile device. Alternatively, the facsimile job may also include an address of the origination facsimile device in the facsimile transmission network 100 and other pertinent information.

To provide one specific example, assume that a scanner client 126 is employed by the user in a first one of the geographical regions 103 for this purpose. Also assume, for example, that the desired destination facsimile device 139 is located in a second one of the geographical regions 103. In this respect, were the user to employ a facsimile machine located in the first geographical region 103 to fax the facsimile job to the destination facsimile device 139, then it may entail a long distance telephone call due to the fact that the respective geographical regions 103 may be located a significant distance from each other. Such a long distance telephone call would be made at greater expense due to the long distance. The facsimile transmission network 100 provides a distinct advantage in that it reduces any potential expensive long distance telephone call to a local telephone call within a given geographical region 103 as will be described.

In addition, it may be the case that the document that is the subject of the facsimile job is not scanned using the scanner client 126, but may be stored in an appropriate memory of one of the clients 123 or the scanner client 126, etc. Regardless of how the document that is the subject of the facsimile job is generated or obtained, assume that the user wishes to transmit the document to the appropriate one of the destination facsimile devices 139. In this respect, the user may interface with facsimile control logic in the scanner client 126 that determines which one of the LAN facsimile servers 133 is within the same geographical region 103 as the destination facsimile device 139. Within each geographical region 103, it is assumed that the LAN facsimile server 133 can reach any one of the destination facsimile devices 139 in the region 103 with a local telephone call or a telephone call of lesser expense. Once the respective LAN facsimile server 133 within the geographical region 103 of the desired destination facsimile device 139 is known, then the scanner client 126 places the facsimile job in the respective input folder 143 of the specific LAN facsimile server 133. Once the facsimile job is placed in the respective input folder 143, the corresponding LAN facsimile server 133 proceeds to transmit the document that is the subject of the facsimile job to the destination facsimile device 139 by way of a local or low cost telephone call.

Alternatively, the selected LAN facsimile server 133 may include multiple input folders 109, each input folder being associated with one of the geographical regions 103. In this situation, the scanner client 126 sends the facsimile job to be placed in the respective input folder 133 associated with the LAN facsimile server 133 that is associated with the geographical region 103 within which the scanner client 126 is located.

Thus, by placing a facsimile job into the input folder 143 of a LAN facsimile server 133 that is local to the destination facsimile device 139, a long distance telephone call may be avoided to communicate the facsimile job. Thus, the scanner client 126 includes the functionality that determines which of the LAN facsimile servers 133 is in the same geographical region 103 as the destination facsimile device 139. Thereafter, the facsimile job is sent by way of the various networks including the respective ones of the LANs 109 and the data communications network 153, and is placed in the respective folder 143 of the LAN facsimile server 133 that is in the same geographical region 103 as the destination facsimile device 139.

Thereafter, the LAN facsimile server 133 that receives the facsimile job in its respective input folder 143 proceeds to determine the telephone number or other identification information associated with the destination facsimile device 139 that was associated with the facsimile job. The LAN facsimile server 133 then places a telephone call over the public switched telephone network 136 to the respective destination facsimile device 139. Thereafter, the LAN facsimile server 133 transmits the document that is the subject of the facsimile job to the respective destination facsimile device 139 over the telecommunications network such as the PSTN 136 using standard facsimile protocols as can be appreciated with ordinary skill in the art.

Once the transmission of the document that is the subject of the facsimile job is complete, then the LAN facsimile server 133 writes a facsimile disposition message back to its respective input folder 143. The facsimile disposition message describes the disposition status of the facsimile job. For example, the facsimile job may have been successfully transmitted, or the transmission may have been interrupted and as a consequence, was unsuccessful. The original scanner client 126 or other device that transmitted the facsimile job to the respective LAN facsimile server 133 then checks the input folder 143 to determine whether the facsimile disposition message associated with the facsimile job is stored therein. In this respect, the scanner client 126 is thus informed as to the ultimate disposition of the facsimile job.

Alternatively, the LAN facsimile server 133 may look up information within the facsimile job to obtain a network address of the originating facsimile device such as, for example, one of the scanner clients 126 on the facsimile transmission network 100. In such case, the LAN facsimile server 133 may transmit the facsimile disposition message directly to the respective origination facsimile device to inform the origination facsimile device as to the ultimate disposition of the facsimile job. By receiving the facsimile disposition message, the respective origination facsimile device is informed as to the disposition of the facsimile job.

If the origination facsimile device is one of the scanner clients 126 that may be employed by multiple users, the scanner client 126 may generate and transmit a message that describes the disposition of the facsimile job to a client 123 associated with the particular user. In this respect, the user may enter the network address such as an email address or other network address of their associated client 123 on a respective one of the LANs 109 into the scanner client 126 when they initiate the transmission of the facsimile job. This network address may then be used by the scanner client 126 in transmitting a message to the user's client 123.

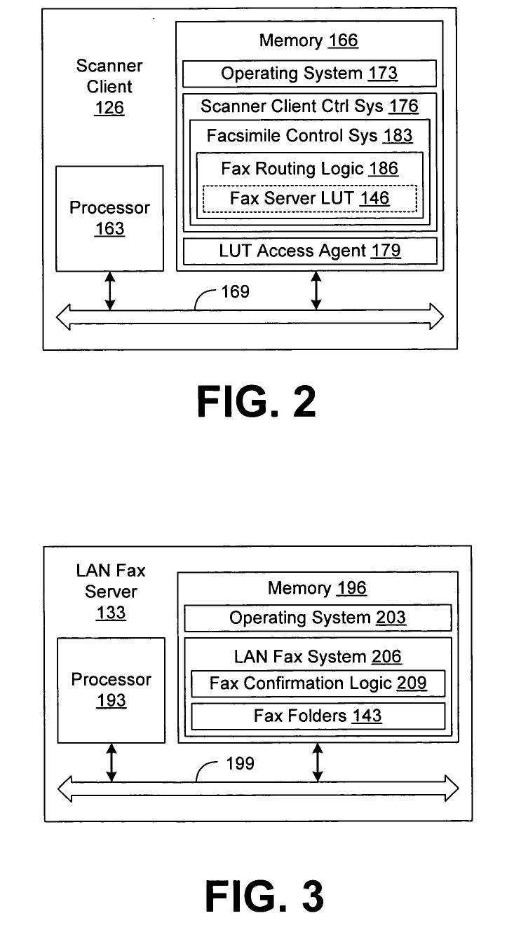

With reference to FIG. 2, shown is a schematic block diagram of one example of a scanner client 126 according to an embodiment of the present invention. In this respect, the scanner client 126 includes a processor circuit having a processor 163 and a memory 166, both of which are coupled to a local interface 169. In this respect, the local interface 169 may comprise, for example, a data bus with an accompanying control/address bus as can be appreciated by those with ordinary skill in the art. In addition, the scanner client 126 may include other components not shown herein, such as, for example, scanning components, copying components, paper path components, and other devices. Alternatively, the scanner client 126 may be, for example, a computer system with a locally attached scanner device as can be appreciated.

Stored in the memory 166 and executable by the processor 163 are several software components including, for example, an operating system 173, a scanner client control system 176, and an LUT access agent 179. The scanner client control system 176 includes all control logic that directs the operations of the scanner client 126 such as, for example, those functions and operations that are performed if the scanner client 126 were a multifunction peripheral or other appropriate device. Such functions may comprise, for example, scanning functions, copying functions, printing functions, facsimile functions, and other functionality. In order to implement the facsimile functions, the scanner client control system 176 includes a facsimile control system 183. The facsimile control system 183 is a component of the scanner client control system 176 that controls operations with respect to the generation and transmission of facsimile jobs. In this respect, the facsimile control system 183 includes facsimile routing logic 186 and the facsimile server LUT 146. The LUT access agent 179 provides for the ability to alter, add to, and delete various entries in the facsimile server LUT 146. In this respect, the LUT access agent 179 may comprise, for example, a web server or other such server that facilitates access and manipulation of the facsimile server LUT 146 using the browser 156.

With reference to FIG. 3, shown is one embodiment of the LAN facsimile server 133 according to an embodiment of the present invention. In this respect, the LAN facsimile server 133 includes a processor circuit 193 and a memory 196, both of which are coupled to a local interface 199. In this respect, the local interface may be, for example, a data bus with an accompanying control/address bus as can be appreciated by those with ordinary skill in the art. The LAN facsimile server 133 may comprise, for example, a computer system or other like device with the same capability. The LAN facsimile server 133 provides the capability of faxing documents to respective destination facsimile devices over the public switched telephone network 136 (FIG. 1) as was described above.

The LAN facsimile server 133 includes a number of components such as, for example, an operating system 203 and a LAN facsimile system 206. The LAN facsimile system 206 comprises logic that is executed by the processor 193 to control all the functions of the LAN facsimile server 133 in transmitting facsimiles to respective ones of the destination devices 139 that are obtained from various components on the respective network 109 to which the LAN facsimile server 133 is coupled. The LAN facsimile system 206 includes, for example, facsimile confirmation logic 209, and one or more facsimile folders 143 as was described above. The facsimile confirmation logic 209 facilitates the generation of facsimile disposition messages that report the disposition status of a respective facsimile job. In this respect, the facsimile disposition messages indicate whether a facsimile job was successfully transmitted.

Each of the memories 166 and 196 are defined herein as both volatile and nonvolatile memory and data storage components. Volatile components are those that do not retain data values upon loss of power. Nonvolatile components are those that retain data upon a loss of power. Thus, each of the memories 166 and 196 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, each of the processors 163 and 193 may represent multiple processors and each of the memories 166 and 196 may represent multiple memories that operate in parallel processing circuits, respectively. In such a case, each of the local interfaces 169 and 199 may be an appropriate network that facilitates communication between any two of the multiple processors, between any processor and any of the memories, or between any two of the memories, etc. The processors 163 and 193 may be of electrical, optical, or molecular construction, or of some other construction as can be appreciated by those with ordinary skill in the art.

The operating systems 173 and 203 are executed to control the allocation and usage of hardware resources such as the memory, processing time and peripheral devices in the scanner client 126 and the LAN facsimile server 133. In this manner, the operating systems 173 and 203 serve as the foundation on which applications depend as is generally known by those with ordinary skill in the art.

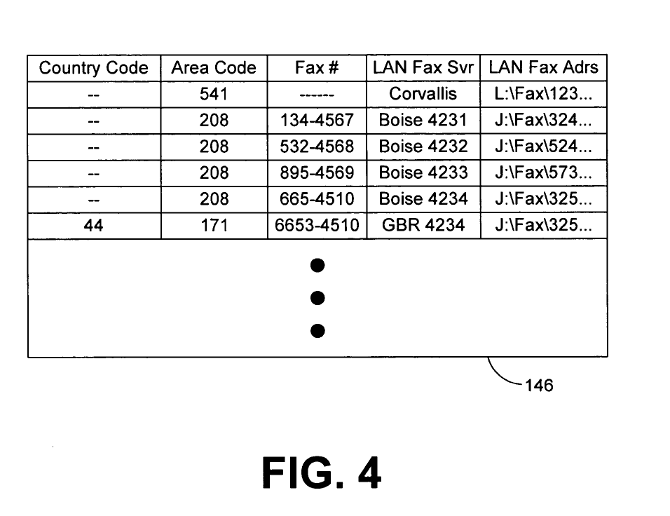

With reference to FIG. 4, shown is one example of the facsimile server LUT 146 according to an embodiment of the present invention. The facsimile server LUT 146 associates at least a portion of the facsimile telephone number of the destination facsimile device 139 with one of the LAN facsimile servers 133. In particular, at least a portion of the facsimile telephone numbers of the destination facsimile devices 139 are associated with the location on a respective LAN 109 of the input folder 143 of a respective LAN facsimile server 133. In some situations, whole telephone numbers may be associated with a respective LAN facsimile server 133. In this respect, the facsimile telephone number, or portions thereof, serve as region identifiers of the geographical region 103 within which the destination facsimile devices 139 are located.

In one embodiment, the portion of the facsimile telephone number of the destination facsimile device 139 that is associated with a respective LAN facsimile server 133 is an area code or country code of the telephone number or a combination or both. In this respect, one or more area or country codes comprise region identifiers that are generally associated with the geographical regions 103 may, in turn, be associated with the respective LAN facsimile server 133. In some situations, the area codes may actually be city codes, etc. In order to look up the respective LAN facsimile server 133 to which a respective facsimile job is to be sent for transmission to the respective destination facsimile device 139, the origination facsimile device such as a scanner client 126 identifies a LAN facsimile server 133 from those listed in the facsimile server LUT 146 based, for example, upon the area code or other portion of the facsimile telephone number associated with the destination facsimile device 139 entered by the user as described above. Alternatively, other identification information associated with the destination facsimile device 139 may be employed as region identifiers that are associated with the respective LAN facsimile servers 133 in the facsimile server LUT 146.

Thus, the facsimile routing logic 186 identifies an area code as the region identifier within the facsimile telephone number associated with the destination facsimile device 139. Alternatively, the facsimile routing logic 186 may identify other information that may be associated with a particular LAN facsimile server 133 in the facsimile server LUT 146 from the facsimile job as entered by a user. It may also be possible that multiple area codes are associated with a single one of the geographical regions 103.

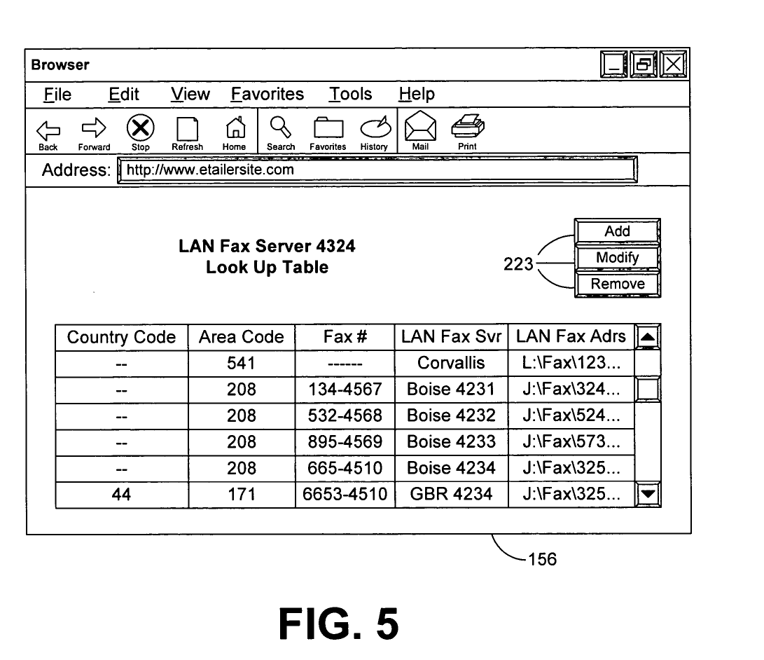

With reference to FIG. 5, shown is a graphical user interface generated, for example, by the browser 156 on the central maintenance client 129 according to an embodiment of the present invention. In this respect, the browser 156 interfaces with the LUT access agent 179 (FIG. 2) to obtain a copy of the facsimile server LUT 146. In this respect, the LUT access agent 179 may be, for example, a web server or other device with like capability that generates a web page incorporating the information from the facsimile server LUT 146. In addition, the LUT access agent 179 includes the logic to write back values to the facsimile server LUT 146 at the direction of a user manipulating the browser 156.

Specifically, the browser 156 provides buttons 223 such as an “Add” button and a “Modify” button, and a “Remove” button. In order to add a new entry in the facsimile server LUT 146, the user may click on or otherwise manipulate the Add button. Similarly, to remove or modify an entry already existing in the facsimile server LUT 146, the user may click on or otherwise manipulate the Modify and Remove buttons, respectively. In this respect, the LUT access agent 179 may provide further graphical user interfaces that facilitate the addition, modification, or removal of various entries in the facsimile server LUT 146 in response to the manipulation of the respective buttons 223. In this manner, the maintenance of the various facsimile server LUTs 146 is centralized at a specific point so that as a particular enterprise grows and creates new geographical regions 103 with LANs 109, any new LAN facsimile servers 133 included therein may be included in all of the facsimile server LUTs 146 in the existing facsimile transmission network 100. This is particularly important when each of the local sites 106 within which the LANs 109 are located are maintained and controlled by one entity, such as a large corporation with multiple work sites as can be appreciated. In such case, such a corporation or other entity may assign one individual the responsibility of maintaining the facsimile server LUTs 146 to provide for lowest cost facsimile routing by reducing the number of long distance calls that may be necessary to communicate various facsimiles from location of the major corporation to another.

In an alternative embodiment, a single facsimile server LUT 146 may be stored in a device on the facsimile transmission network 100 (FIG. 1) that is remotely consulted by each of the scanner clients 126 (FIG. 1). In this respect, only a single facsimile server LUT 109 need be maintained for each of the LAN scanner clients 126. In an additional alternative, a LUT update agent (not shown) may be located in each of the scanner clients 126 that automatically maintains synchronization between the facsimile server LUT 146 in a respective scanner clients 126 and a central facsimile server LUT (not shown) stored in a central device located in the facsimile transmission network 100. Using any of these approaches, each of the scanner clients 126 can maintain an up-to-date listing of each LAN facsimile server 133 to which facsimile jobs may be sent for transmission to various destination facsimile devices by way of least cost telephone calls over the PSTN 136 (FIG. 1).

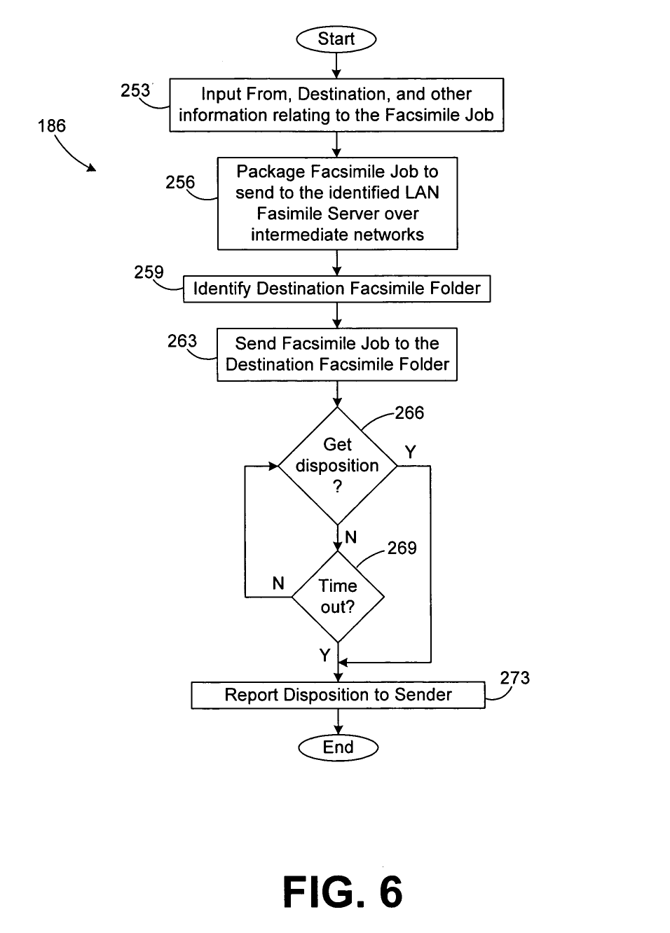

Referring next to FIG. 6, shown is a flow chart that provides one example of the operation of the facsimile routing logic 186 according to an embodiment of the present invention. Alternatively, the flow chart of FIG. 6 may be viewed as depicting steps of an example of a method implemented in a scanner client 126 or other device to transmit a facsimile job by way of a least cost telecommunications link. The functionality of the facsimile routing logic 186 as depicted by the example flow chart of FIG. 6 may be implemented, for example, in an object oriented design or in some other programming architecture. Assuming the functionality is implemented in an object oriented design, then each block represents functionality that may be implemented in one or more methods that are encapsulated in one or more objects. The facsimile routing logic 186 may be implemented using any one of a number of programming languages such as, for example, C, C++, or other programming languages.

Beginning with box 253, the user of the scanner client 126 manipulates the facsimile routing logic 186 to input various information associated with the facsimile job such as, for example, a “FROM” designation, the destination designation such as the destination facsimile device facsimile telephone number, and other information relating to the facsimile job. Other information may be, for example, the network address such as an email address of the user for receipt of a facsimile disposition message, the total number of pages, and other information. Such information may be entered into the scanner client 126 (FIG. 1) using an appropriate user interface that includes, for example, a LCD display screen and appropriate push buttons, or a CRT with a keyboard, a touch screen, or other user interface devices, etc.

Alternatively, a user may enter authentication information such as a username and a password for authentication purposes. In such case, access may be granted in order to transmit a facsimile job using an appropriate authentication protocol such as Lightweight Directory Access Protocol (LDAP) that facilitates access to a director server on a respective LAN 109 (FIG. 1).

Assuming that all of the information associated with a particular facsimile job is input in box 253, then in box 256 the facsimile routing logic 186 packages the particular facsimile job for transmission to the identified LAN facsimile server 133 over the respective LANs 109 and the data communications network 153 (FIG. 1). In this respect, a predefined protocol may be employed to package the document and associated facsimile job information in a manner that is recognizable to the respective LAN facsimile servers 133 that are to receive such facsimile jobs for transmission to the respective destination devices 139 and that facilitates the transfer of the facsimile job over the various networks 109/153. For example, the information input in box 253 may be placed in a header that is attached to the digital representation of the document that is the subject of the facsimile job.

Thereafter, in box 259, the facsimile routing logic 186 determines the particular LAN facsimile server 133 to which the facsimile job is to be routed. In particular, the input folder 143 of the respective LAN facsimile server 133 is identified in which the facsimile job is to be stored for transmission over the PSTN 136 as described above. Where multiple input folders 143 are associated with a particular LAN facsimile server 133, then the particular one of the multiple folders is identified. This may be the case, for example, where each of the multiple folders is associated with a particular one of the geographical regions 103. In such case, the facsimile routing logic 186 may place the facsimile job in the folder associated with the geographical region 103 within which the scanner client 126 is located.

Next, in box 263, the facsimile job is sent to the LAN facsimile server 133 for transmission to the respective destination facsimile device 139. Specifically, the facsimile job is stored in the appropriate input folder 143 of the LAN facsimile server 133. Thereafter, in box 266, the facsimile routing logic 186 determines whether a facsimile disposition has been determined with respect to the facsimile job. In this respect, the facsimile routing logic 186 may examine the input folder 143 to determine whether a facsimile disposition message has been generated by the respective LAN facsimile server 133 that describes the disposition status of the facsimile job. Alternatively, the facsimile routing logic 186 may wait to receive a facsimile disposition message from the respective LAN facsimile server 133 by way of the LANs 109 and the data communications network 153, respectively. Assuming that the disposition of the facsimile job is determined in box 266 then the facsimile routing logic jumps to box 273.

If no facsimile disposition is determined in box 266, then the facsimile routing logic 186 proceeds to box 269 in which it is determined whether a time out has occurred such that the facsimile routing logic 186 has waited an inordinate amount of time to determine the disposition of the facsimile. Assuming that the time out has occurred, then the facsimile routing logic 186 assumes that the facsimile job was not successfully transmitted to the destination facsimile device 139 and proceeds to box 273. Otherwise, the facsimile routing logic 186 reverts back to box 266.

Thus, in boxes 266 and 269, after the facsimile job is placed in the respective input folder 143, the facsimile routing logic 186 waits for a predefined period of time to obtain a disposition as to the status of the facsimile job. If no disposition is forthcoming, then it is assumed that an error condition exists and that the facsimile job was not successfully transmitted. Otherwise assuming that a disposition is received then in box 273, a report is transmitted to the sender of the facsimile job as to the disposition status of the facsimile job.

In this respect, the report may be transmitted to the user email address or other network address entered in box 253 to inform the sender of the facsimile job as to the ultimate result. Assuming that the facsimile job was not successfully transmitted, then the sender may take such steps as to resend that facsimile job. Alternatively, the function of box 273 may be omitted where a respective scanner client 126 is not configured to transmit a facsimile disposition message to a separate client 123 associated with a particular user. Thereafter, the facsimile routing logic 186 ends as shown.

Although the facsimile routing logic 186 is embodied in software or code executed by general purpose hardware as discussed above, as an alternative it may also be embodied in dedicated hardware or a combination of software/general purpose hardware and dedicated hardware. If embodied in dedicated hardware, the facsimile routing logic 186 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow chart of FIG. 6 shows the architecture, functionality, and operation of an implementation of the facsimile routing logic 186. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow chart of FIG. 6 shows a specific order of execution, it is understood that the order of execution may differ from that which is depicted. For example, the order of execution of two or more blocks may be scrambled relative to the order shown. Also, two or more blocks shown in succession in FIG. 6 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the facsimile routing logic 186 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the facsimile routing logic 186 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

1. A method of transmitting a facsimile job, comprising:
generating, in an origination facsimile device, the facsimile job that includes a document and a facsimile telephone number of a destination facsimile device;
identifying, in the origination facsimile device, a select facsimile server associated with the destination facsimile device from a plurality of facsimile servers, each of the facsimile servers being coupled to the origination facsimile device via at least one data communications network; and
sending the facsimile job to the select facsimile server through the at least one data communications network, wherein the select facsimile server transmits the document to the destination facsimile device through a telecommunications network.

2. The method of claim 1, wherein the step of identifying, in the origination facsimile device, a select facsimile server associated with the destination facsimile device from a plurality of facsimile servers further comprises the step of looking up the select facsimile server in a table that associates at least a portion of the facsimile telephone number with the select facsimile server.

3. The method of claim 2, further comprising the step of identifying an area code in the facsimile telephone number as the portion of the facsimile telephone number that is associated with the select facsimile server.

4. The method of claim 1, further comprising the step of receiving, in the origination device, a facsimile disposition message from the select facsimile server via the at least one data communications network, the facsimile disposition message describing a disposition status of the facsimile job.

5. The method of claim 4, further comprising the step of forwarding the facsimile disposition message to a client device associated with the sender of the facsimile job.

6. The method of claim 1, further comprising the step of storing the facsimile job in one of a plurality of folders associated with the select facsimile server, wherein the one of the plurality of folders is further associated with a region within which the origination facsimile device is located.

7. The method of claim 1, further comprising the step of storing the facsimile job in a folder associated with the select facsimile server.

8. The method of claim 7, further comprising the step of checking the folder to determine if the facsimile job has been transmitted to the destination facsimile device.

9. The method of claim 8, wherein the step of checking the folder to determine if the facsimile job has been transmitted to the destination facsimile device further comprises the step of determining if a facsimile disposition message associated with the facsimile job is stored in the folder, the facsimile disposition message describing a disposition status of the facsimile job.

10. The method of claim 1, wherein the step of identifying, in the origination facsimile device, the select facsimile server associated with the destination facsimile device from the plurality of facsimile servers further comprising the steps of:
associating each of the facsimile servers with a corresponding plurality of region identifiers; and
identifying one of the region identifiers in the facsimile telephone number.

11. A system for facsimile transmission in an origination facsimile device, comprising:
a processor circuit having a processor and a memory;
facsimile routing logic stored in the memory and executable by the processor, the facsimile routing logic further comprising:
logic that generates a facsimile job that that includes a document and a facsimile telephone number associated with a destination facsimile device;
logic that identifies a select facsimile server associated with the destination facsimile device from a plurality of facsimile servers based upon the facsimile telephone number associated with the destination facsimile device, each of the facsimile servers being coupled to the origination facsimile device via at least one data communications network; and
logic that sends the facsimile job directly to the select facsimile server through the at least one data communications network, wherein the select facsimile server transmits the document to the destination facsimile device through a telecommunications network.

12. The system of claim 11, further comprising logic that forwards a facsimile disposition message received from the select facsimile server to a client device associated with the sender of the facsimile job, the facsimile disposition message describing a disposition status of the facsimile job.

13. The system of claim 11, wherein the logic that sends the facsimile job directly to the select facsimile server through the at least one data communications network further comprises logic that stores the facsimile job in a folder associated with the select facsimile server.

14. The system of claim 13, wherein the logic that sends the facsimile job directly to the select facsimile server through the at least one data communications network further comprises logic that stores the facsimile job in one of a plurality of folders associated with the select facsimile server, wherein the one of the plurality of folders is further associated with a region within which the origination facsimile device is located.

15. The system of claim 13, further comprises logic that checks the folder to determine if the facsimile job has been transmitted to the destination facsimile device.

16. The system of claim 15, further comprises logic that determines if a facsimile disposition message associated with the facsimile job is stored in the folder after the facsimile job has been stored in the folder, the facsimile disposition message describing a disposition status of the facsimile job.

17. A system for facsimile transmission in an origination facsimile device, comprising:
means in the origination facsimile device for generating a facsimile job that that includes a document and a facsimile telephone number, the facsimile telephone number being associated with a destination facsimile device;
means in the origination facsimile device for identifying a select facsimile server associated with the destination facsimile device from a plurality of facsimile servers based upon the facsimile telephone number associated with the destination facsimile device, each of the facsimile servers being coupled to the origination facsimile device via at least one data communications network; and
means for sending the facsimile job directly to the select facsimile server through the at least one data communications network, wherein the select facsimile server transmits the document to the destination facsimile device through a telecommunications network.

18. The system of claim 17, further comprising means for forwarding a facsimile disposition message received from the select facsimile server to a client device associated with the sender of the facsimile job, the facsimile disposition message describing a disposition status of the facsimile job.

19. The system of claim 17, wherein the means for sending the facsimile job directly to the select facsimile server through the at least one data communications network further comprises means for storing the facsimile job in a folder associated with the select facsimile server.

20. The system of claim 19, further comprising means for checking the folder to determine if the facsimile job has been transmitted to the destination facsimile device.
